(19) United States
(12) Patent Application Publication
(10) Pub. No.: US 2005/0184133 A1
(43) Pub. Date: Aug. 25, 2005

(54) Laser cleaning system for a wire bonding machine

(75) Inventors: Horst Clauberg, North Wales, PA (US); Ronald J. Focia, Stevens, PA (US); David T. Beatson, Kenneth Square, PA (US); Kenneth Kyle Dury, Kihei, HI (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Kulicke and Soffa Investments, Inc.

(21) Appl. No.: 11/065,193

(22) Filed: Feb. 24, 2005

Related U.S. Application Data
(60) Provisional application No. 60/548,049, filed on Feb. 25, 2004.

(51) Int. Cl. B23K 1/20

(52) U.S. Cl. 228/203; 228/18

(57) ABSTRACT

A wire bonding system for attaching a wire between bonding pads on a semiconductor device and a substrate. The wire bonding system includes a frame and a bonding head attached to the frame and adapted to attach a wire between bonding pads on a semiconductor device and a substrate. The wire bonding system also includes a laser cleaning mechanism mounted to the frame, the laser cleaning mechanism including a laser for emitting laser light adapted to irradiate contaminants on a bonding pad, the laser mechanism located on the frame so as to emit light onto a bonding pad of at least one of the semiconductor device and the substrate prior to the bonding head attaching the wire thereto.

### RELATED APPLICATION

The present application is related to and claims priority from U.S. Provisional Application Ser. No. 60/548,049, filed Feb. 25, 2004, which is incorporated herein by reference in its entirety.

### FIELD OF THE INVENTION

The present invention relates to a cleaning system for a wire bonding process and, more particularly, to a laser cleaning mechanism for eradicating contaminants on a bonding surface, such as a wire bonding pad or bonding wire.

### BACKGROUND OF THE INVENTION

Wire bonding is the most commonly used method of connecting semiconductor devices to their supporting substrates. In this method, a fine wire of, usually, gold, copper, or aluminum is ultrasonically or thermosonically welded to bond pads on the semiconductor device and the substrate. Wire Bonding in Microelectronics by G. Harman (McGraw-Hill, New York, 1997) provides a thorough review of such wire bonding process. Wire bonding falls within two broad categories: ball bonding and wedge bonding. The present invention relates to both of these processes equally well.

One of the problems that can adversely affect the bonding of a wire to a bonding pad on a semiconductor device or substrate is the presence of contaminants on the bonding pads and/or the wire being bonded. Such contaminants may be present for a variety of reasons. For example, oxide layers readily form on certain metals, such as copper or aluminum, when exposed to the atmosphere or during certain processing steps of the semiconductor. Such oxide layers can interfere with the bonding process. In the case of aluminum bonding pads, aluminum oxides are hard and, if too thick, cannot be broken sufficiently during the bonding process. Copper oxides are an even more serious problem. Soft and lubricious, they reduce the friction due to the ultrasonic motion of the ball or wire on the surface and thereby prevent bonding or reduce the quality of the bond.

Various forms of organic contaminants can also develop on a bonding surface from exposure to the environment. This includes oils that may result from human contact with the surface. There may also be residue remaining from the fabrication process, such as die attach adhesives, residue from the dicing operation or fluoride contaminants from the IC manufacturing process. These all adversely impact the bonding process.

Traditionally, bonding pads on the die and the substrates are cleaned using a low-pressure plasma in a batch plasma cleaner. Being a separate batch process, it is usually carried out several hours before the bonding process. Such extended time delays between cleaning and bonding allow for re-contamination or re-oxidation of the bonding surfaces. Such plasma cleaning also tends to be ineffective in removing many of the kinds of contaminants mentioned above. Oxides, fluorides and dicing debris are some of the contaminants against which plasma cleaning is not particularly effective. Such contaminants, if present, usually reduce yield in the wire bonding operation or require alternate cleaning techniques.

Laser cleaning has been used in separate cleaning systems for cleaning various devices. See for example, U.S. Pat. Nos. 6,573,702; 6,494,217; 6,291,796; 6,066,032; and 5,643,472, the disclosures of which are all incorporated herein by reference in their entireties.

A need exists for an improved system for cleaning a wire and/or bonding pad to facilitate the attachment of the wire to the pad and to improve the quality and reliability of the bond.

### SUMMARY OF THE INVENTION

According to an exemplary embodiment of the present invention, a wire bonding system for attaching a wire between bonding pads on a semiconductor device and a substrate is provided. The wire bonding system includes a frame and a bonding head attached to the frame and adapted to attach a wire between bonding pads on a semiconductor device and a substrate. The wire bonding system also includes a laser cleaning mechanism mounted to the frame, the laser cleaning mechanism including a laser for emitting laser light adapted to irradiate contaminants on a bonding pad, the laser cleaning mechanism located on the frame so as to emit light onto a bonding pad of at least one of the semiconductor device or the substrate prior to the bonding head attaching the wire thereto.

According to another exemplary embodiment of the present invention, another wire bonding system for attaching a wire between bonding pads on a semiconductor device and a substrate is provided. The wire bonding system includes a frame and a bonding head attached to the frame and adapted to receive a wire for attachment between bonding pads on a semiconductor device and a substrate. The wire bonding system also includes a wire and a laser cleaning mechanism mounted to the frame. The laser cleaning mechanism includes a laser for emitting laser light adapted to illuminate a portion of the wire prior to bonding of the wire. The laser is mounted to the frame so as to emit light in a direction at least partially toward the wire.

According to yet another exemplary embodiment of the present invention, a method of attaching a wire between bonding pads of a semiconductor device and a substrate is provided. The method includes emitting laser light in the proximity of at least one of (a) a portion of a wire adapted to be attached between bonding pads of a semiconductor device and a substrate, (b) a bonding pad of the semiconductor device, or (c) a bonding pad of the substrate, to irradiate contaminants thereon. The method also includes attaching the wire between the bonding pad of the semiconductor device and the bonding pad of the substrate.

### BRIEF DESCRIPTION OF THE DRAWINGS

For the purpose of illustrating the invention, the drawings show several embodiments of the present invention. However, it should be understood that this invention is not limited to the precise arrangements and instrumentalities shown in the drawings.

FIG. 1 is an isometric schematic drawing of a portion of a wire bonding machine incorporating a laser cleaning mechanism according to one embodiment of the invention.

FIG. 2 is an isometric schematic drawing of a portion of a wire bonding machine incorporating an alternate embodiment for directionally controlling the light emitted from a laser.

FIG. 3 is an isometric schematic drawing of a portion of a wire bonding machine incorporating rotatable mirrors for directionally controlling the light emitted from a laser.

FIG. 4 is an isometric schematic drawing of a portion of a wire bonding machine incorporating a micro laser as a portion of the laser cleaning mechanism according to the present invention.

FIG. 5 is an isometric schematic drawing of a portion of a wire bonding machine incorporating a mask for controlling the laser exposure of the parts to be cleaned according to the methods of the present invention.

FIG. 6 is an isometric schematic drawing of a portion of a wire bonding machine incorporating the use of a gas shrouding device for the area being laser cleaned according to the methods of the present invention.

FIG. 7 is an isometric schematic drawing of a portion of a wire bonding machine incorporating a laser cleaning mechanism for the purpose of cleaning the bonding wire according to the present invention.

### DESCRIPTION OF THE PREFERRED EMBODIMENTS

Referring to the drawings, wherein like reference numerals represent similar components throughout the views, various exemplary embodiments of the invention are shown related to laser cleaning Systems for irradiating contaminants on a bonding pad on a semiconductor device and/or substrate.

As used herein, the term “contaminant” is intended to refer to any undesirable substance present on a contact or wire. For example, such contaminants include organic contaminants, inorganic contaminants, oxides, etc.

As used herein, the term “frame” is intended to refer to any support structure for supporting a wire bonding head and the parts to be bonded. While exemplary support structures (i.e., frames) are illustrated in the figures accompanying the present application, the term frame is not limited to the illustrated embodiments. Further, a “frame” may also be used to support the laser cleaning mechanism according to the present invention. The frame supporting the laser cleaning mechanism may be the same frame used to support the wire bonding head. Alternatively, two distinct frames (support structures) may be used to support each of the laser cleaning mechanism and the wire bonding head. Thus, a single “frame” described herein can relate to distinct support structures.

As used herein, the term semiconductor device refers to any of a number of devices including semiconductor dies, semiconductor chips, integrated circuits, etc., and any other device intended to be wire bonded to a substrate.

As used herein, the term substrate refers to any structure to which a semiconductor device is wire bonded, including but not limited to printed circuit boards, cards, etc.

As used herein, the term bonding pad refers to any contact on (which includes contacts integrated as part of) a semiconductor device or a substrate to which a wire is bonded.

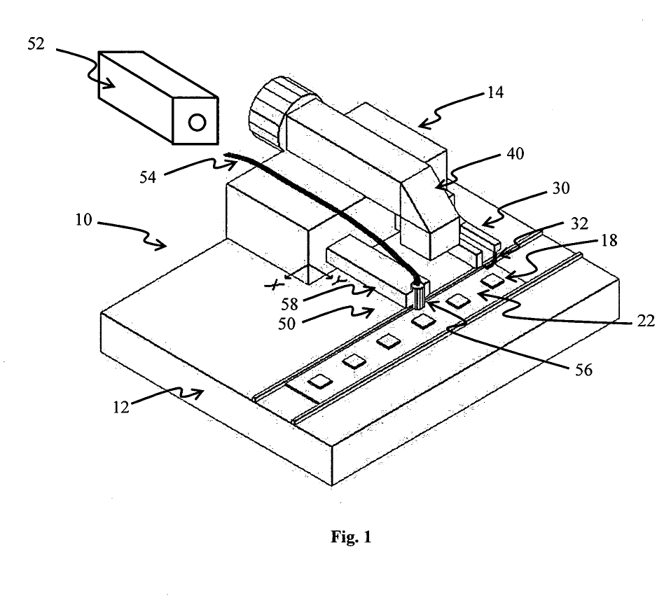

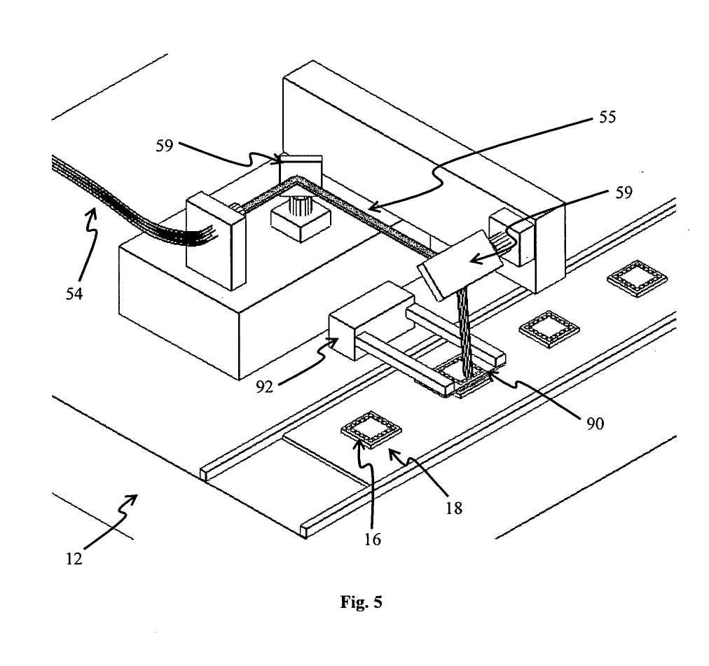

FIG. 1 illustrates a schematic representation of a portion of one wire bonding machine 10 incorporating the present invention. The laser cleaning system of the present invention can be used with any wire bonding machine. However, one preferred machine is sold by Kulicke & Soffa Industries, Willow Grove, Pa., under the trade name Maxμm. The wire bonding machine 10 includes a frame 12 which supports a reciprocating wire bonding head 14. The wire bonding head 14 generally has an ultrasonic transducer 30 to which a bonding tool (capillary or wedge) 32 is mounted. The wire to be bonded passes through the bonding tool. The wire bonding head 14 is designed to feed and secure a length of wire between a bonding pad 16 (not shown in FIG. 1, see FIG. 5) on a semiconductor device 18 and a wire bonding pad (not shown) on a substrate 22 in a conventional manner. To accomplish the task, the wire bonding head 14 can move in both horizontal directions (generally referred to as X and Y) and the transducer 30 and bonding tool 32 additionally move in the vertical (Z) direction. A vision system 40 is usually mounted to the bonding head to identify and locate the bonding pads. Apart from the discussion that follows, the details of the wire bonding machine 10 are conventional.

In one preferred embodiment, a laser cleaning mechanism 50 is mounted to the wire bonding machine 10 and, more preferably, to the frame 12. The laser cleaning mechanism includes a laser 52 for emitting a beam of light which is adapted to illuminate at least a portion of one or more of the wire bonding pads for eradicating at least a portion of the contaminants that may be present on the bonding pads. As discussed above, it is common during fabrication of a semiconductor device and/or substrate for contaminants, such as oils, debris, etc., to find their way to various points on a semiconductor device or substrate. One such area is the contact or bonding location (bonding pad) on the semiconductor device and/or substrate. The laser mechanism 50 is mounted and constructed so as to clean away at least a portion of the contaminants on those areas by illuminating the bonding pad with a suitable wavelength of light selected to eradicate the contaminants.

Preferably, the laser light has a wavelength of between approximately 140 to 1700 nm, but more preferably, in a range between approximately 180 nm and 1200 nm, and even more preferably in a range between approximately 200 nm and 550 nm. These ranges of wavelength interact sufficiently with the contaminants or the bonding pads to cause absorption of at least a portion of the laser light. Various lasers can be used in the present invention, such as Nd-YAG, Nd-glass, Nd-YLF, Er-YAG, excimer, Ti-sapphire, or diode lasers. Such lasers are well known in the art and, thus, no further discussion is needed regarding their construction or operation. Suitable lasers are sold by Melles Griot, Spectra Physics, Inc., and Coherent, Inc. One preferred light source for use in the present invention is a diode-laser pumped Nd-YAG laser. Another preferred laser light is a micro laser such as the one described in U.S. Pat. No. 5,394,413, which is incorporated herein by reference in its entirety. A suitable micro laser is sold by Northrop Grumman as “ML Series Microlaser.”

In one preferred embodiment, the laser is pulsed with a pulse length of between approximately 5 femtoseconds (fs) and approximately 500 nanoseconds (ns). More preferably, the laser is pulsed in a range of between approximately 100 picoseconds (ps) and approximately 100 ns.

It is also contemplated that the laser system may include a non-linear optical device, such as one of the devices employing non-linear optical crystals, which convert the fundamental laser beam wavelength to its 2^{nd}, 3^{rd} or 4^{th} harmonic depending on the wavelength needed. Such non-linear optical devices are commonly used in the laser industry and need not be described in further detail. The optimal wavelength is selected so as to best remove the contaminants. It is contemplated that in some embodiments, the cleaning process may involve the ablation of a thin (submicron) surface layer of the bond pad metallization. Generally, the shorter the wavelength, the lower the power that is needed to remove a surface layer of the bonding pad. Non-linear optical devices for wavelength conversion are commonly used for producing short wavelength laser light.

The laser light can be controlled in any known manner. An optical fiber 54 is one convenient method of controlling the laser light. FIG. 1 schematically illustrates the use of an optical fiber to bring the light from a laser 52 mounted elsewhere on the wire bonding machine to the semiconductor device 18 and/or its substrate 22. In one preferred embodiment, illustrated in FIG. 1, one end of the optical fiber 54 and an optical system 56 are attached to the bonding head 14. In this manner, the X-Y motion of the bonding head is used to steer the laser light onto the bonding pads to be cleaned. It is also contemplated that information from the vision system 40 may be used to precisely direct the laser light to the desired locations on the semiconductor device and/or substrate. In some embodiments, the laser light may need to be relatively highly (strongly) focused. In such embodiments, the vertical position of the focal point may be adjusted by either moving the mounting arm 58 of the laser up and down or by mechanically adjusting lenses within the optical system 56. In other embodiments, the laser may be sufficiently powerful to effect the cleaning action even if the laser light is not focused or only slightly focused onto the bonding pads. In such embodiments, Z control of the lens system 56 is not required.

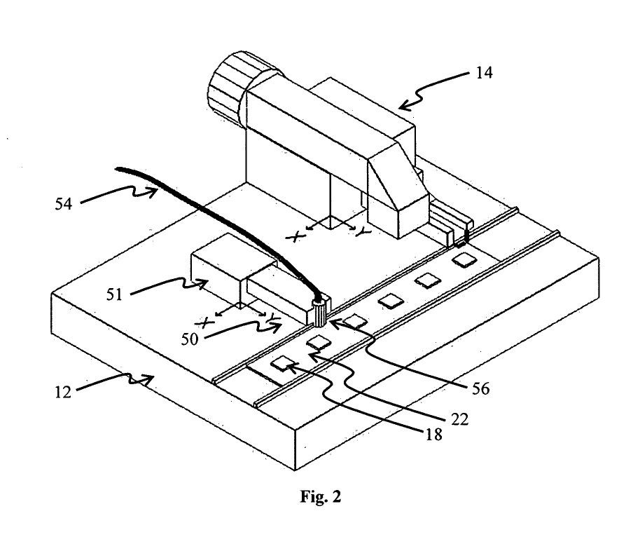

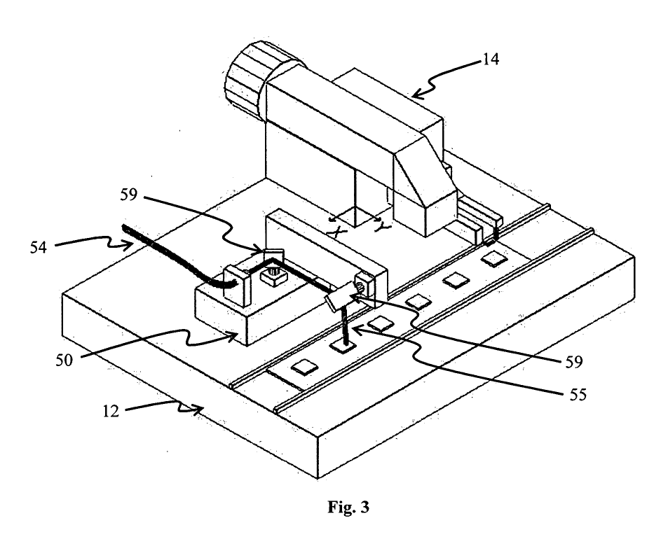

In other embodiments, the laser light delivery system 50 may be mounted to the frame 12 separately from the bonding head 14. Examples of such embodiments are shown in FIGS. 2 and 3. Mounting the laser beam delivery system separately from the bond head allows the cleaning of bonding pads on semiconductor devices and an associated substrate, while simultaneously wire bonding another, already cleaned, semiconductor device. Such embodiments incorporate separate systems for controlling the X, Y and, in some cases Z, position of the laser light. As illustrated in FIG. 2, the laser light control system may involve a second X-Y or X-Y-Z stage 51. Alternatively, a system of two or more rotatable (or otherwise adjustable) mirrors 59 may be used to control the X and Y position of the laser light. Such a system is illustrated in FIG. 3. A combination of moving stages and rotatable/adjustable mirrors may also be used. FIG. 3 illustrates laser light beam 55 directed toward a semiconductor device using mirrors 59. For precise control of the laser light, a second vision system analogous to the one of the bond head can also be employed.

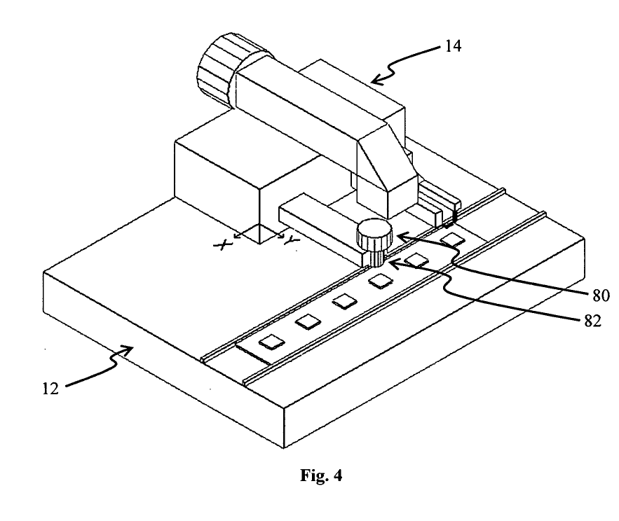

In another preferred arrangement of the present invention, a micro laser 80 is mounted to a movable framing structure with an optical system. FIG. 4 schematically illustrates an example of such an embodiment. The fiber optic cable and lens system in any of the previously discussed embodiments can be replaced with a micro laser. An appropriate optical system 82 is attached directly to the micro laser.

Although a number of different methods for delivering the laser light to the areas to be cleaned have been discussed, this invention is not limited to the specific embodiments described above.

In some embodiments, the laser light required to cause effective cleaning of the bonding areas is sufficiently powerful to cause damage to other parts of the semiconductor die or its substrate. In order to prevent damage to the die and/or the substrate during cleaning, it is preferable that the laser optical system is controlled to minimize irradiation of areas that do not need to be cleaned. For example, it is preferable to minimize exposure of the areas surrounding a bonding pad on the semiconductor device to avoid unacceptable damage to the passivation layers surrounding the bonding pads, as well as the structures that may be located below the passivation coating. As discussed in many of the above embodiments, the laser beam may be focused to a small area and an X-Y steering mechanism may be used to prevent excessive irradiation of sensitive parts of the die or substrate. However, is some embodiments, the laser beam itself may be larger than the areas to be cleaned. To prevent damage to areas outside the region to be cleaned, a mask 90 may be incorporated into the optical system of the laser cleaning mechanism. FIG. 5 illustrates one such configuration. The mask 90 would shield sensitive areas of the die or substrate, while allowing the laser light to impinge onto the bonding pads through openings in the mask 90. The mask 90 is preferably mounted on a movable stage 92 to align it with the die and/or substrate. A vision system separate from the one on the bond head may be used to control such alignment.

It is also contemplated that a gas system may be used before, during and/or after illumination of the component with the laser light. For example, a gas, such as compressed air, can be used to blow away the debris/gases that result from the laser illumination of the bonding pad. If it is desirable to prevent oxidation from developing on a cleaned area, it is preferable that the gas be either an inert gas, such as nitrogen, argon or helium, or provide a chemically reducing atmosphere, such as a mixture of an inert gas and hydrogen. This is especially desirable for copper substrates and/or copper bonding pads and for silver-plated leads on substrates.

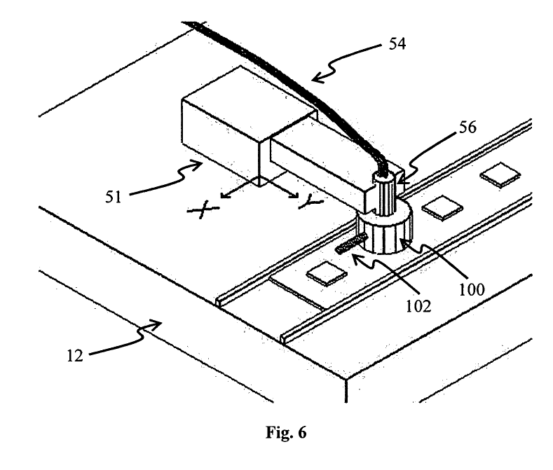

Instead of the gas being blown onto the cleaned area, it may be desirable, especially in the case of oxidation sensitive pads or wires, to create and maintain an inert cover gas around the cleaned component even after cleaning. An example of a system for shrouding the area being cleaned with an inert gas is shown in FIG. 6. The inert gas enters the shrouded area 100 through a tube 102. Alternatively, the cleaning and bonding can occur in a chamber. Yet another possibility is to apply moderate suction to the area being cleaned. A system such as that shown in FIG. 6 can be used for this purpose by applying a vacuum to the tube 102, rather than gas pressure as described previously. Debris from the laser cleaning process may also be prevented from settling on the bonding pads by application of a slight vacuum to the top portion of a light-shielding mask of the type described above and illustrated in FIG. 5.

One of the benefits of the present invention is the ability to clean the device and substrate immediately before bonding due to the location of the cleaning system directly on the wire bonding machine. This minimizes the development of oxide layers or debris on the bonding pad between cleaning and bonding.

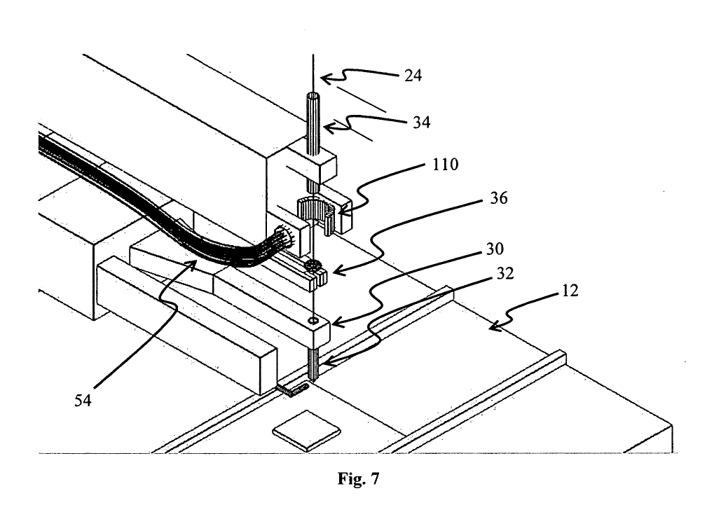

While the present invention has been described for use in cleaning a bonding pad, it is also contemplated that the laser cleaning system can be used to clean the wire that is to be bonded onto the pad. Furthermore, it is also contemplated that the laser light can be selected so as to cleanse any coatings that may be present on a wire, such as oxide layers, lubricants and even protective or insulative coatings. This embodiment is particularly useful for cleaning the portion of the wire that produces the second bond, i.e. the end of the wire opposite the one that had a ball formed on it. FIG. 7 schematically illustrates a laser cleaning mechanism for the bonding wire according to the present invention. In one embodiment, the laser light is directed against all sides of the wire 24 through the use of a fiber optic 54 and a parabolic or cylindrical mirror 110. The preferred location for irradiating the wire is above the wire clamps 36, but below the wire tensioning tube 34. Alternately or in addition, the laser light can be moved relative to the wire or more than one laser could be used so as to facilitate irradiation of the circumference of the wire. It should be readily apparent that many of the features described above with respect to cleaning bonding pads, such as using a mask, a controlled environment, etc., are equally applicable to the laser cleaning of a wire.

### EXAMPLE

The following example illustrates the effectiveness of laser cleaning for improving the second bond strength of wire-bonded devices. Three test devices were wire bonded on a Kulicke & Soffa model 8028 PPS wire bonder using 1 mil Kulicke & Soffa AW99 gold wire. The test devices were attached to identical plastic ball grid area (BGA) substrates with gold-plated bond pads. Test device A was wire bonded without any cleaning, whereas the gold-plated 2^{nd} bond pads on the substrates for devices B and C were laser-cleaned using a New Wave Research QuickkLaze II Nd-YAG laser prior to wire bonding. Laser cleaning was performed using 532 nm laser light passing through a 20× objective to produce a spot size of approximately 100 μm. The areas to be cleaned on the substrate were passed under the laser beam at a rate of 200 μm/s. The laser was operated at a pulse repetition rate of 40 Hz. The laser power was set to 40% (4 mW) and 50% (5 mW) for cleaning devices B and C, respectively. The strength of the wire bond connections was tested by destructively pulling the second bonds using a Dage 4000 pull/shear tester. The table below shows the results of the pull test. These results clearly demonstrate the usefulness of laser cleaning for improving wire bond strengths.

2nd Bond Pull
Strength (g)

| Device | Cleaning | Average | Std. dev. |
|---|---|---|---|
| A | None | 6.30 | 0.56 |
| B | Laser (40% power) | 7.82 | 0.81 |
| C | Laser (50% power) | 8.77 | 0.46 |

Although the present invention has been described and illustrated largely in terms of a laser cleaning mechanism disposed above a surface to be cleaned (while transmitting laser energy directly downward in a vertical direction), it is not limited thereto. The laser energy may be transmitted from a number of directions towards the surface to be cleaned. For example, it may be desirable to transmit the laser energy on an angle (e.g., an angle between 20 and 90 degrees) towards the surface to be cleaned. In such embodiments, the bonding tool (or camera) may be directly above the surface to be cleaned (e.g., the bonding site) such that after the laser energy has cleaned the surface (from a position not directly above the surface), the bonding tool may immediately perform the desired bonding operation. Such a configuration provides a more time-efficient cleaning and bonding process.

The present invention may be embodied in other specific forms without departing from the spirit or essential attributes thereof and, accordingly, reference should be made to the appended claims, rather than to the foregoing specification, as indicating the scope of the invention.

1. A wire bonding system for attaching a wire between bonding pads on a semiconductor device and a substrate, the wire bonding system comprising:
a frame;
a bonding head attached to the frame and adapted to attach a wire between bonding pads on a semiconductor device and a substrate; and
a laser cleaning mechanism mounted to the frame, the laser cleaning mechanism including a laser for emitting laser light adapted to irradiate contaminants on a bonding pad, the laser cleaning mechanism located on the frame so as to emit light onto a bonding pad of at least one of the semiconductor device or the substrate prior to the bonding head attaching the wire thereto.

2. The wire bonding system of claim 1 wherein a wavelength of the laser light is between 180 nm and 1200 nm.

3. The wire bonding system of claim 1 wherein a wavelength of the laser light is between 200 nm and 550 nm.

4. The wire bonding system of claim 1 wherein the laser light is pulsed during the irradiation of contaminants with a pulse width of between 5 femtoseconds and 500 nanoseconds.

5. The wire bonding system of claim 1 additionally comprising a control system for controlling at least one of an X, Y, and Z position of the laser light, the control system including at least one rotatable mirror.

6. The wire bonding system of claim 1 wherein the laser is a micro laser.

7. The wire bonding system of claim 1 wherein the laser includes a non-linear optical device for converting a fundamental laser beam wavelength of the laser to a desired harmonic wavelength.

8. The wire bonding system of claim 1 wherein the laser includes a mask for shielding a portion of at least one of the semiconductor device or the substrate from the laser light.

9. The wire bonding system of claim 1 wherein the wire bonding system includes a gas system for supplying a gas at least in proximity to a bonding pad subjected to the laser light.

10. The wire bonding system of claim 1 wherein the wire bonding system includes a vacuum system for supplying a vacuum at least in proximity to a bonding pad subjected to the laser light.

11. A wire bonding system for attaching a wire between bonding pads on a semiconductor device and a substrate, the wire bonding system comprising:
a frame;
a bonding head attached to the frame and adapted to receive a wire for attachment between bonding pads on a semiconductor device and a substrate;
a wire; and
a laser cleaning mechanism mounted to the frame, the laser cleaning mechanism including a laser for emitting laser light adapted to illuminate a portion of the wire prior to bonding of the wire, the laser mounted to the frame so as to emit light in a direction at least partially toward the wire.

12. The wire bonding system of claim 11 wherein a wavelength of the laser light is between 180 nm and 1200 nm.

13. The wire bonding system of claim 11 wherein a wavelength of the laser light is between 200 nm and 550 nm.

14. The wire bonding system of claim 11 wherein the laser light is pulsed during the irradiation of contaminants with a pulse width of between 5 femtoseconds and 500 nanoseconds.

15. The wire bonding system of claim 11 additionally comprising a control system for controlling at least one of an X, Y, or Z position of the laser light, the control system including at least one rotatable mirror.

16. The wire bonding system of claim 11 wherein the laser is a micro laser.

17. The wire bonding system of claim 11 wherein the laser includes a non-linear optical device for converting a fundamental laser beam wavelength of the laser to a desired harmonic wavelength.

18. The wire bonding system of claim 11 wherein the laser includes a mask for shielding a portion of at least one of the wire, the semiconductor device, or the substrate from the laser light.

19. The wire bonding system of claim 11 additionally comprising a gas system for supplying a gas at least in proximity to the wire subjected to the laser light.

20. The wire bonding system of claim 11 additionally comprising a vacuum system for supplying a vacuum at least in proximity to the wire subjected to the laser light.

21. A method of attaching a wire between bonding pads of a semiconductor device and a substrate, the method comprising the steps of:
emitting laser light in the proximity of at least one of (a) a portion of a wire adapted to be attached between bonding pads of a semiconductor device and a substrate, (b) a bonding pad of the semiconductor device, or (c) a bonding pad of the substrate, to irradiate contaminants thereon; and
attaching the wire between the bonding pad of the semiconductor device and the bonding pad of the substrate.

22. The method of claim 21 further comprising the step of:
applying at least one of (a) a gas pressure, or (b) a vacuum, in proximity of at least one of the wire, the bonding pad of the semiconductor device, or the bonding pad of the substrate.
